(19) United States
(12) Patent Application Publication
(10) Pub. No.: US 2004/0135488 A1
(43) Pub. Date: Jul. 15, 2004

(54) Flat display panel

(75) Inventor: Masaomi Ebe, Yamanashi (JP)

Correspondence Address: SUGHRUE MION, PLLC, 2100 PENNSYLVANIA AVENUE, N.W., SUITE 800, WASHINGTON, DC, 20037, US

(73) Assignees: PIONEER CORPORATION; PIONEER DISPLAY PRODUCTS CORPORATION

(21) Appl. No.: 10/624,891

(22) Filed: Jul. 23, 2003

(30) Foreign Application Priority Data
Jul. 24, 2002 (JP) P2002-214683

(51) Int. Cl. H01J 1/62

(52) U.S. Cl. 313/491

(57) ABSTRACT

A seal plate is installed for sealing tightly an exhaust hole provided to a glass substrate of the back side of a PDP (flat display panel). The air is directly exhausted from internal spaces via the exhaust hole and gas is sealed into an enclosure. The seal plate is heat-secured to the exhaust hole so as to seal the internal spaces tightly.

### CROSS REFERENCE OF RELATED APPLICATION

This application is based on and claims priority under 35 U.S.C. §119 with respect to Japanese Patent Application No. 2002-214683 filed on Jul. 24, 2002, the entire content of which is incorporated herein by reference.

### BACKGROUND OF THE INVENTION

The present invention relates to a flat display panel such as a plasma display panel (PDP), a field emission display panel, a fluorescent display tube panel and so forth and a method of producing a flat display panel.

FIG. 1 shows the schematic partial structure of a plasma display panel (hereinafter called the PDP) on a surface discharge type AC drive system. The structure of the PDP on the surface discharge type AC drive system will be described as follows.

As shown in FIG. 1, the PDP 10 has a glass substrate 11a on the display surface side. A plurality of line electrode pairs X and Y formed with transparent electrodes and thick-film metal electrodes are arranged in parallel to each other on the glass substrate 11a. A dielectric layer 12 is formed so as to cover these line electrodes X and Y and a protective layer of magnesium oxide (MgO) (not shown) is piled up thereon.

On the other hand, a glass substrate 11b is also provided on the back side and a plurality of column electrodes 13 are provided in parallel to each other on the inner side of the glass substrate 1b at predetermined intervals. The column electrodes 13 are covered with phosphor layers 14. The glass substrate 11a of the display surface side and the glass substrate 11b of the back side are provided in a separated condition so that the line electrodes X and Y cross the column electrodes 13 at right angles.

Internal spaces 15 as discharge spaces are formed between both the glass substrates 11a and 11b and filled with rare gas as a discharge gas sealed into an enclosure. Further, there are formed partition walls 16 having a predetermined height between the column electrodes 13 on the glass substrate 11b of the back side so as to section the plurality of line electrode pairs X and Y and the plurality of intersecting column electrodes 13 into unit luminous areas having a predetermined luminous surface area.

A seal layer 17 is formed in the outer peripheral non-display area of the glass substrate 11b of the back side, the seal layer 17 being formed by applying fritted paste so as to surround a display area and calcining the paste. An exhaust hole 18 is provided in the glass substrate 111b of the back side. A chip tube 20 for the exhaust hole 18 is perpendicularly mounted onto the back surface of the glass substrate 11b of the back side via a sealing agent 19.

Enclosure of the rare gas in the PDP 10 is conducted as shown in FIG. 2. First, an exhaust jig 21 having a switch valve is mounted onto the chip tube 20, The exhaust jig 21 is made attachable to the chip tube by an O-ring 22 in an airtight condition. A vacuum pump and a gas cylinder are connected to the exhaust jig 21 and the switch valve of the vacuum pump is opened to draw the vacuum between the glass substrates 11a and 11b using the vacuum pump so as to exhaust the air.

Then the rare gas from the gas cylinder is sealed into an enclosure by opening the switch valve of the gas cylinder. When the sealing of the rare gas into an enclosure is completed, the opening of the chip tube 20 is as shown in FIG. 3 sealed tightly by heat fusion and the rare gas is sealed in between the two sheets of glass substrates 11a and 11b before the exhaust jig 21 is removed.

In the case of the PDP 10 above, however, the chip tube 20 used to exhaust the air and enclose the rare gas is unremovable and remains projected from the back of the PDP 10; consequently, there is a problem arising from an obstacle to reducing the thickness of the PDP 10.

### SUMMARY OF THE INVENTION

An object of the invention made in consideration of the foregoing problems is to provide a flat display panel designed to realize a reduction in the thickness of a flat display panel and a method of producing such a flat display panel.

In order to accomplish the above object, according to one aspect of the invention, there is provided a flat display panel including two sheets of substrates, a seal layer, an exhaust hole, and a seal plate, wherein the peripheries of two sheets of substrates are sealed with the seal layer via a predetermined gap held therebetween and that the exhaust hole is provided in one of the two sheets of substrates, and wherein the exhaust hole is sealed tightly by the seal plate.

In addition, according to a second aspect of the invention, there is provided a method of producing a flat display panel such that the peripheries of two sheets of substrates are sealed with a seal layer via a predetermined gap held therebetween and that an exhaust hole is provided in one of the two sheets of substrates, the method including, directly exhausting the air from the exhaust hole, and heat-securing the seal plate to the exhaust hole so as to seal the exhaust hole tightly.

### BRIEF DESCRIPTION OF THE DRAWINGS

These and other objects and advantages of this invention will become more fully apparent from the following detailed description taken with the accompanying drawings in which;

FIG. 1 is a sectional view of a conventional PDP;

FIG. 2 is a sectional view showing the steps of exhausting the air and introducing gas into the conventional PDP;

FIG. 3 is a sectional view showing a sealing step in the conventional PDP;

FIG. 4 is a sectional view of PDP according to an embodiment of the invention;

FIG. 5 is a sectional view of the PDP and an exhaust seal unit according to the embodiment of the invention;

FIG. 6 is a diagram illustrating a seal plate;

FIG. 7 is a flowchart showing a processing flow in the process of sealing internal spaces tightly by directly exhausting the air from the internal spaces via an exhaust hole and heat-securing the seal plate in a method of producing the PDP according to the embodiment of the invention;

FIG. 8 is a sectional view showing a sealing process in the PDP according to the embodiment of the invention;

FIG. 9 is a sectional view showing another embodiment of an exhaust seal unit according to the invention.

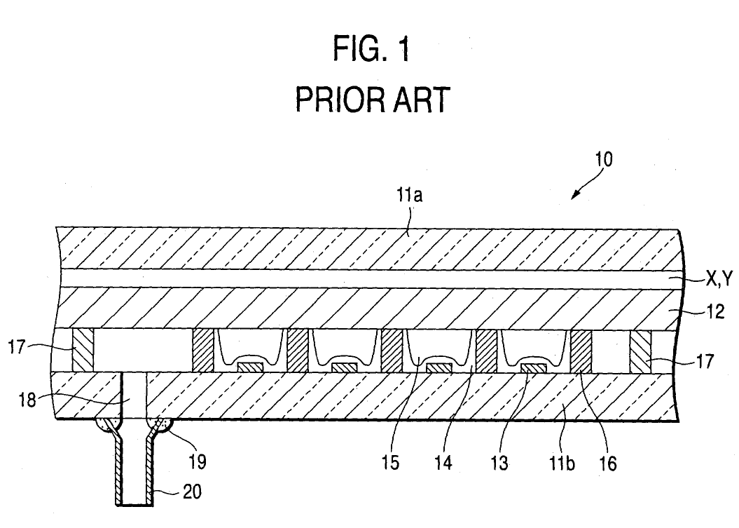

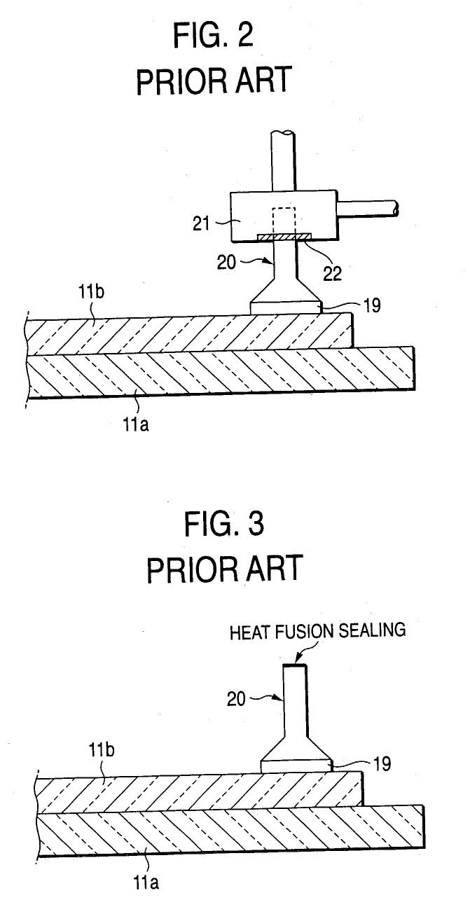

### DETAILED DESCRIPTION OF THE PREFERRED EMBODIMENTS

An embodiment of the invention will now be described with reference to the drawings.

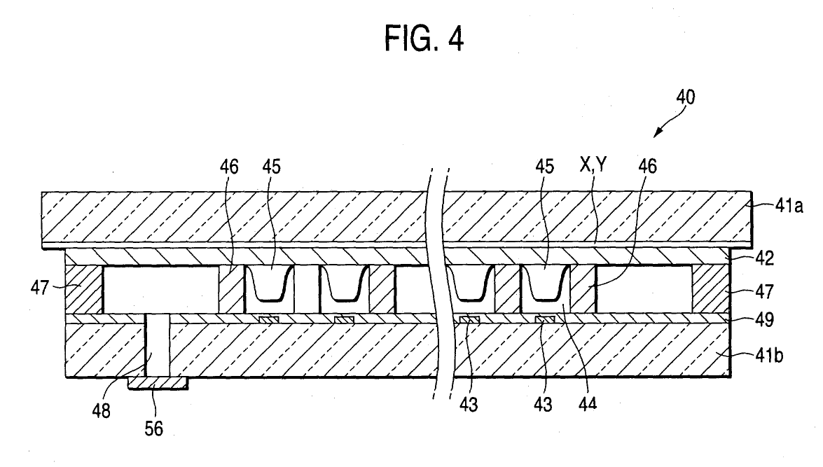

FIG. 4 is a sectional view illustrating a PDP according to this embodiment of the invention.

As shown in FIG. 4, two sheets of glass substrates 41a and 41b are stuck together by sealing a PDP 40 with a seal layer 47 via partition walls 46. On the glass substrate 41a of the display surface side, a plurality of line electrode pairs X and Y having transparent electrodes and thick-film metal electrodes are arranged in parallel to each other. Further, a dielectric layer 42 for covering these line electrode pairs X and Y is formed and a protective layer of magnesium oxide (MgO) (not shown) is piled up on the dielectric layer 42.

On the other hand, a glass substrate 41b is also provided on the back side and a plurality of column electrodes 43 are provided in parallel to each other on the inner side of the glass substrate 41b at predetermined intervals. A column-electrode protective layer (dielectric layer) 49 for protecting the column electrodes 43 is formed and phosphor layers 44 are provided. The glass substrate 41a of the display surface side and the glass substrate 41b of the back side are provided in a separated condition so that the line electrodes X and Y cross the column electrodes 13 at right angles.

Internal spaces 45 as discharge spaces are formed between both the glass substrates 41a and 41b and filled with rare gas as a discharge gas sealed into an enclosure.

Further, there are formed partition walls 46 having a predetermined height between the column electrodes 43 on the glass substrate 41b of the backside so as to section the plurality of line electrode pairs X and Y and the plurality of intersecting column electrodes 43 into unit luminous areas having a predetermined luminous surface area.

A seal layer 47 is formed in the outer peripheral non-display area of the glass substrate 41b of the back side, the seal layer 47 being formed by applying fritted paste so as to surround a display area and calcining the paste, so that the internal spaces 45 are sealed tightly by both the glass substrates 41a and 41b and the seal layer 45. An exhaust hole 48 communicating with the internal spaces is provided in the glass substrate 41b of the back side.

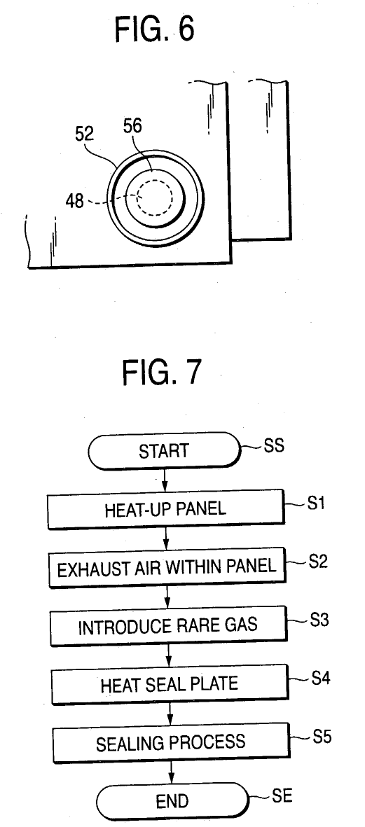

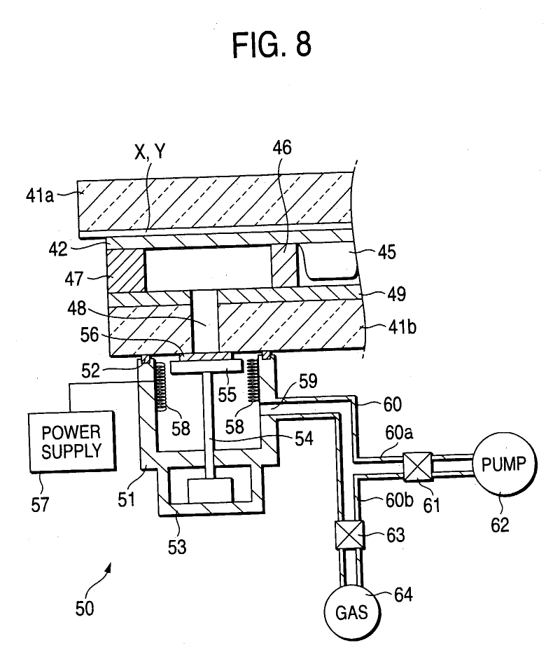

A seal plate 56 is mounted over the backside of the glass substrate 41b for the exhaust hole 48. As the seal plate 56 is used to close the exhaust hole 48, the seal plate 56 needs to have an outer diameter large enough to seal the exhaust hole 48 tightly. In other words, as shown in FIG. 6, the seal plate 56 is in the form of a large button whose outer diameter is smaller than the inner diameter of an O-ring 52 but larger than the inner diameter of the exhaust hole 48.

The seal plate 56 is formed of pressed frit prepared by pressing crystalline low melting glass powder approximately 2 mm or less in thickness into a disc.

Moreover, the thermal expansion coefficient of the seal plate 56 is preferably 0.8-0.65 time the thermal expansion coefficient of the glass substrate 41b of the back side. In case that the glass substrate 41b of the back side is made of soda glass, the thermal expansion coefficient of the seal plate 56 is in the order of 60×10⁻⁷/° C.-95×10⁻⁷/° C.

Incidentally, use can be made of low-melting glass ‘GA-0963’, ‘LS-3081’, ‘LS-0118’, ‘LS-0206’ or ‘LS-7105’ of Nippon Electric Glass Co., Ltd. These products are mixtures of crystalline low-melting glass powder and ceramic powder and their thermal expansion coefficients are in the order of 60×10⁻⁷/° C.-85×10⁻⁷/° C. and their softening points are in the order of 400° C.

The seal plate 56 may be formed of a glass plate offering high infrared-ray absorbency. As such a glass plate providing high infrared-ray absorbency, ‘STI’, ‘SAX’ or “SRI” of Nippon Electric Glass Co., Ltd. may be referred to by way of example with their thermal expansion coefficients in the order of 90×10⁻⁷/° C.-95×10⁻⁷/° C. and their softening points ranging from 635C° to 650C°.

In this case, the outer surface of the seal plate 56 thus secured is preferably covered with dampproofing resin so as to prevent dampness from penetrating into the internal spaces 45. As a dampproofing resin usable at this time, silicone resin “KE-3424G” made by Shin-Etsu Chemical Co., Ltd. may be referred to by way of example.

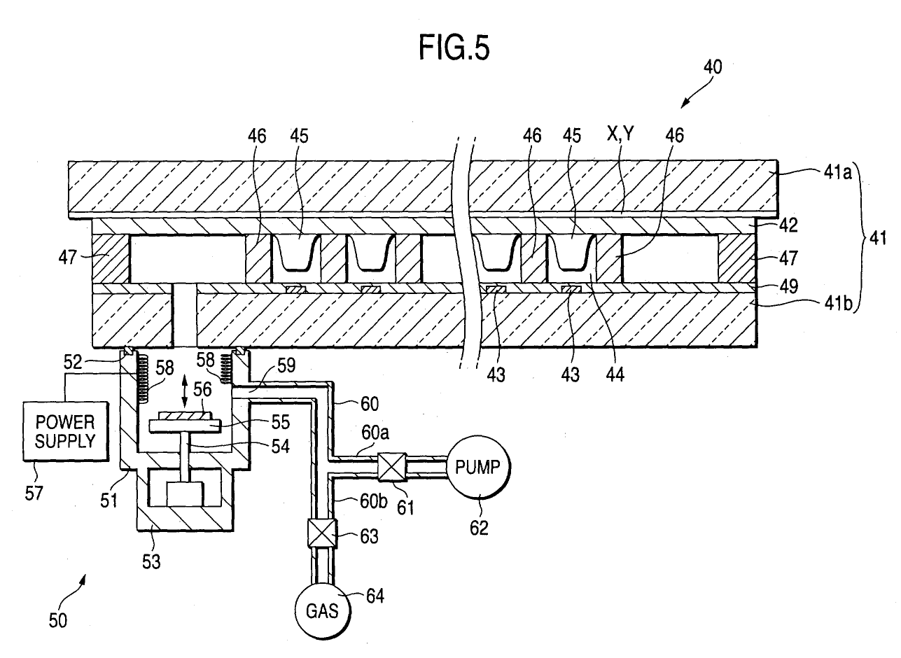

An exhaust seal unit for use in the method of producing the PDP according to this embodiment of the invention will subsequently be described. FIG. 5 is a sectional view of the PDP 40 and an exhaust seal unit 50, showing such a condition as to exhaust the air and to seal the discharge gas into an enclosure.

As shown in FIG. 5, the exhaust seal unit 50 is mounted on the outer side of the glass substrate 41b of the back side. The exhaust seal unit 50 has a boxlike exhaust seal unit body 51 and the O-ring 52 is fitted to the front edge face of the exhaust seal unit body 51. Consequently, the exhaust seal unit 50 is mounted onto the glass substrate 41b of the back side via the O-ring 52 in such a manner as to contain the exhaust hole 48.

An air cylinder 53, for example, as an seal-plate elevating mechanism portion is mounted onto the exhaust seal unit body 51. A support plate 55 is fitted to the front end (upper end of FIG. 4) of the piston rod 54 of the air cylinder 53. The seal plate 56 for sealing the exhaust hole 48 tightly is mounted on the support 55.

A heater 58 for generating heat on receiving power from a power supply 57 is provided in the front end portion of the inner side of the exhaust seal unit body 51 (the end portion close to the glass substrate 41b of the back side) A hole 59 is provided inside the outer side (lower side in FIG. 5) of the heater 58 on the side of the exhaust seal unit body 51 and a pipe 60 is fitted therein.

The piping 60 branches off and one pipe 60a is connected to a vacuum pump 62 via an exhaust valve 61, whereas the other pipe 60b is connected to a gas supply portion 64 via a gas valve 63.

A description will subsequently be given of the step of sealing the internal spaces tightly by heat-securing the seal plate after directly exhausting the air from the internal spaces and sealing the gas into an enclosure via the exhaust hole in the method of producing the PDP according to this embodiment of the invention. FIG. 7 is a flowchart showing a processing flow.

As shown in FIG. 7 (concurrently referring to FIG. 5), the panel 41 formed by sticking the glass substrate 41a of the display surface side and the glass substrate 41b of the back side together is subjected to heat-up (Step S1). Then the air in the panel is exhausted by closing the gas valve 63 and opening the exhaust valve 61 (Step S2).

On completion of exhaustion, the rare gas is introduced from the gas supply portion 64 into the internal spaces 45 by closing the exhaust valve 61 and opening the gas valve 63 (Step S3).

The rare gas as a discharge gas has neon and xenon as the main ingredients.

Upon termination of the introduction of the rare gas after the gas has reached a predetermined pressure, the power supply 57 is switched on to turn on the heater 58 whereby to heat the surface of the seal plate 56 (Step S4).

When the seal plate 56 is softened, the exhaust hole 48 is sealed tightly by pressing the seal plate 56 against the glass substrate 41b of the back side by means of the air cylinder to perform the sealing process (Step S5 (see FIG. 7)).

Then the introduction of the discharge gas is terminated by returning the air cylinder 53 and removing the exhaust seal unit 50 from the glass substrate 41b of the back side (Step SE). The PDP shown in FIG. 4 is thus formed.

As set forth above, since the air is directly exhausted from the exhaust hole 48 provided in the glass substrate 41b of the back side, it is unnecessary to provide the chip tube projecting from the glass substrate 41b of the back side as before. As a result, the PDP is as thick as the plate of the panel 41, which makes it possible to make the PDP 40 thinner.

Moreover, the step of mounting an exhaust tube onto the glass substrate 41b of the back side becomes unnecessary because the exhaust tube like the chip tube is unemployed, whereby working efficiency can be improved.

The PDP 40 according to the invention is not limited to what has been described according to this embodiment of the invention but may properly be modified, improved and so forth. For example, though the heater 58 is used as means for heating the seal plate 56 according to the above embodiment of the invention, infrared rays may be used for heating purposes when the seal plate 56 is made of glass that is excellent in infrared-ray absorbency. Laser beams may be used likewise.

Although a description has been given of a case where the exhaust hole 48 is provided in the glass substrate 41b of the back side according to the above embodiment of the invention, the exhaust hole 48 may be provided in the glass substrate 41a of the display surface side.

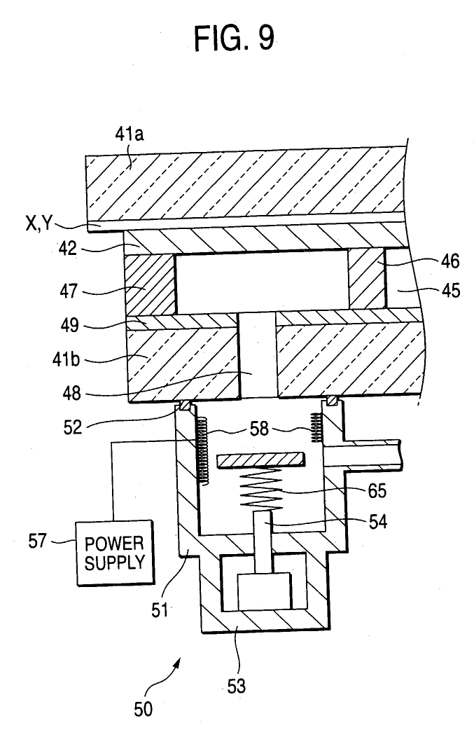

As shown in FIG. 9, the seal plate 56 maybe pressed against the exhaust hole 48 via a spring 65 by fitting the spring 65 to the front end of the piston rod 54.

The structure of sealing the PDP has been shown by way of example according to the above embodiment of the invention. However, the sealing structure according to the invention is widely applicable to field emission display panels and any other display panel such as a fluorescent display tube panel having an exhaust hole.

What is claimed is:

1. A flat display panel comprising:
two sheets of substrates;
a seal layer;
an exhaust hole; and
a seal plate,
wherein the peripheries of two sheets of substrates are sealed with the seal layer via a predetermined gap held therebetween and that the exhaust hole is provided in one of the two sheets of substrates,
and wherein the exhaust hole is sealed tightly by the seal plate.

2. The flat display panel according to claim 1 further comprising:
an exhaust seal unit,
wherein the seal plate is heat-secured to one of the two sheets of substrates by the exhaust seal means.

3. The flat display panel according to claim 1,
wherein the seal plate is formed of pressed frit prepared by press-molding crystalline low-melting glass powder and calcining the molded part.

4. The flat display panel according to claim 1,
wherein the seal plate is formed of a glass plate providing high infrared-ray absorbency.

5. The flat display panel according to claim 1,
wherein one of the substrates is formed of a glass substrate,
and wherein the thermal expansion coefficient of the seal plate is 0.8-0.65 time the thermal expansion coefficient of one of the glass substrates.

6. The flat display panel according to claim 1,
wherein one of the substrates is formed of a glass substrate,
and wherein the thermal expansion coefficient of the seal plate is set at 60×10⁻⁷/° C.-95×10⁻⁷/° C.

7. The flat display panel according to claim 1,
wherein the outer surface of the seal plate is covered with a dampproofing resin.

8. A method of producing a flat display panel such that the peripheries of two sheets of substrates are sealed with a seal layer via a predetermined gap held therebetween and that an exhaust hole is provided in one of the two sheets of substrates, the method comprising:
directly exhausting the air from the exhaust hole; and
heat-securing the seal plate to the exhaust hole so as to seal the exhaust hole tightly.
